(19) United States
(12) Patent Application Publication
(10) Pub. No.: US 2024/0071224 A1
(43) Pub. Date: Feb. 29, 2024

(54) AUTOMATIC LIGHT SIGNALING BICYCLE COMMUNICATION SYSTEM

(71) Applicants: KAM KWONG ALLEN WONG, New Taipei City (TW); HO LUN WONG, New Taipei City (TW)

(72) Inventors: KAM KWONG ALLEN WONG, New Taipei City (TW); HO LUN WONG, New Taipei City (TW)

(21) Appl. No.: 17/898,507

(22) Filed: Aug. 30, 2022

(51) Int. Cl. G08G 1/0969

(52) U.S. Cl. CPC G08G 1/0969

(57) ABSTRACT

An automatic light signaling bicycle communication system includes a wireless relay module, a light module, and an external master device. The wireless relay module includes a relay processing unit and a relay communication unit. The relay processing unit controls the relay communication unit to wirelessly communicate with the external master device according to a simplified network protocol. When the relay processing unit receives a brake command through the relay communication unit according to the simplified network layer protocol file, the relay processing unit generates a relay brake command and broadcasts the relay brake command to a light communication unit of the light module according to MAC protocol, allowing a light processing unit of the light module to light up a brake light automatically. The light module only requires a low cost RF receiver chip for receiving broadcasted commands, rather than requiring an expensive chip for handling network communications.

### BACKGROUND OF THE INVENTION

### 1. Field of the Invention

The present invention relates to a bicycle communication system, particularly an automatic light signaling bicycle communication system.

### 2. Description of the Related Art

In modern times, various types of vehicles are digitally controlled to perform navigations, turn signaling, and other maneuver actions. Such advanced digital systems are often seen in electric cars or electric scooters, and are often costly reliant on expensive chips with network communication abilities to receive orders.

Bicycles are one of the cheapest vehicle options among various existing types of vehicles, and therefore to bicycle makers or modifiers, it would be in their best interest to enhance bicycles with digital systems without drastically increasing the manufacturing cost.

However, in order to digitally control bicycles, either wires or wireless receivers are needed to connect various parts of the bicycles with a digital controller. Using wires to facilitate a digital system for a bicycle is considered a less ideal option due to its potential hazard of wires interfering with wheels, cranks, brakes, or other moving parts of a bicycle.

Using wireless receivers to connect various parts of the bicycles with a digital controller avoids having wires interfering with moving parts of the bicycle. However, as previously mentioned, wireless communication often relies on chips with network communication abilities, and as various parts of the bicycles all require such chips to receive wireless orders, the manufacturing cost or modification cost of a bicycle is high, and therefore it also becomes too costly to modify the bicycle.

In an analogy, an ideal digital communication system of the bicycle should be able to enjoy benefits of a Layer 3 Network Layer in an Open System Interconnection Model (OSI model). However, to wirelessly achieve such communication benefits and qualities for the bicycle, it would seem that a requirement of multiple expensive chips with network communication abilities is inevitable to manufacture or modify the bicycle.

### SUMMARY OF THE INVENTION

The present invention provides an automatic light signaling bicycle communication system. The automatic light signaling bicycle communication system requires only one single chip equipped with network communication abilities, and yet is still able to facilitate limited but sufficient communication benefits and qualities of a Layer 3 Network Layer in an Open System Interconnection Model (OSI model) for a bicycle. The current invention uses a low cost RF (radio frequency) transmitter in a wireless relay module and one or more RF receivers on slave modules to control the bicycle wirelessly. One of the slave modules being wirelessly controlled is a light module. As such, manufacturing cost or modification cost of the bicycle is significantly decreased, and thus proves the inventiveness of the present invention.

The automatic light signaling bicycle communication system includes:
an external master device;
a wireless relay module, including:
   a relay processing unit;
   a relay battery unit, electrically connecting to the relay processing unit;
   a relay communication unit, electrically connecting to the relay processing unit;
wherein the relay processing unit controls the relay communication unit to wirelessly communicate with the external master device according to a network protocol;
a light module, comprising:
   a light communication unit;
   a light processing unit, electrically connecting to the light communication unit;
   a light unit, electrically connecting to the light processing unit;
wherein when the relay processing unit receives a brake command through the relay communication unit from the external master device, the relay processing unit generates a relay brake command and broadcasts the relay brake command to the light communication unit of the light module through the relay communication unit according to a media access control (MAC) protocol; and
wherein when the light processing unit receives the relay brake command through the light communication unit of the light module, the light processing unit controls the light unit to light up according to the relay brake command.

In one embodiment, the wireless relay module and the light module are respectively mounted on a bicycle. The external master device is a smart device installed with an application (APP). The external master device has a GPS (Global Positioning System) receiver and uses the GPS receiver to obtain a motion information of the external master device. When the external master device determines the external master device is slowing down according to the motion information, the external master device generates a brake command and sends the brake command to the relay processing unit.

The present invention uses the wireless relay module as a relay between the network protocol and the MAC protocol, therefore in reality, only a RF transmitter chip used in the wireless relay module requires network communication ability, and a simple RF receiver chip used in the light module is much cheaper in cost for just receiving the relay brake command. In other words, the present invention allows the light module to be commanded in a manner as if the light module exists with the external master device on a Layer 3 Network Layer in an Open System Interconnection Model (OSI model), wherein in fact the light communication unit of the light module only requires the simple RF receiver chip that is able to receive the relay brake command according to MAC protocol. The light communication unit of the light module is also able to receive other relayed commands such as turn signaling commands according to MAC protocol.

Furthermore, the present invention uses the external master device to generate the brake command. The wireless relay module only relays the brake command as the relay brake command to the light module. This means that, for the convenience and benefits of automatically signaling the light unit when needed, the present invention makes use of an expensive chip in the external master device to handle processing loads of determining when to generate the brake command, and the RF transmitter chip used in the wireless relay module in comparison is much cheaper without needing to handle such processing loads. Since a user of the present invention most likely already owns the smart device, the expensive chip used in the external master device is considered pre-existing in the context of the user using the present invention.

Since the RF transmitter chip used in the wireless relay module is free from generating the brake light command, and since the simple RF receiver used in the light module only requires an ability to receive the relay brake light command according to MAC protocol, a manufacturing cost or a modification cost of the bicycle is significantly decreased for the chips used in the wireless relay module and the light module, and thus proves the inventiveness of the present invention. The present invention is able to lower the manufacturing cost or the modification cost of the bicycle for the functionality of controlling the light module in a network manner, and automatically signaling the light unit of the light module for the bicycle.

### BRIEF DESCRIPTION OF THE DRAWINGS

FIG. 1 is a block diagram of an automatic light signaling bicycle communication system of the present invention.

FIG. 2 is a block diagram of the automatic light signaling bicycle communication system in a first embodiment of the present invention.

FIG. 3 is an explosion view of a wireless relay module of the automatic light signaling bicycle communication system in the first embodiment of the present invention.

FIG. 4 is a perspective view of the wireless relay module of the automatic light signaling bicycle communication system in the first embodiment of the present invention.

FIG. 5 is another block diagram of a wireless relay module of the automatic light signaling bicycle communication system in the first embodiment of the present invention.

FIG. 6A is a perspective view of an external master device installed with an application.

FIG. 6B is another perspective view of the external master device installed with the application.

FIG. 7A is a perspective view of a light module of the automatic light signaling bicycle communication system in the first embodiment of the present invention.

FIG. 7B is a block diagram of the light module of the automatic light signaling bicycle communication system in the first embodiment of the present invention.

FIG. 8A is a perspective view of the light module of the automatic light signaling bicycle communication system in a second embodiment of the present invention.

FIG. 8B is a block diagram of the light module of the automatic light signaling bicycle communication system in the second embodiment of the present invention.

FIG. 9A is a perspective view of the external master device when a remaining distance is calculated to be 4.4 meters.

FIG. 9B is a perspective view of the light module of the automatic light signaling bicycle communication system when the remaining distance is calculated to be 4.4 meters.

FIG. 9C is a perspective view of the wireless relay module of the automatic light signaling bicycle communication system when the remaining distance is calculated to be 4.4 meters.

FIG. 10A is a perspective view of the external master device when the remaining distance is calculated to be 3.1 meters.

FIG. 10B is a perspective view of the light module of the automatic light signaling bicycle communication system when the remaining distance is calculated to be 3.1 meters.

FIG. 10C is a perspective view of the wireless relay module of the automatic light signaling bicycle communication system when the remaining distance is calculated to be 3.1 meters.

FIG. 11A is a perspective view of the external master device when the remaining distance is calculated to be 1.8 meters.

FIG. 11B is a perspective view of the light module of the automatic light signaling bicycle communication system when the remaining distance is calculated to be 1.8 meters.

FIG. 11C is a perspective view of the wireless relay module of the automatic light signaling bicycle communication system when the remaining distance is calculated to be 1.8 meters.

FIG. 12A is a perspective view of the external master device when the remaining distance is calculated to be 17.5 meters.

FIG. 12B is a perspective view of the light module of the automatic light signaling bicycle communication system when the remaining distance is calculated to be 17.5 meters.

FIG. 12C is a perspective view of the wireless relay module of the automatic light signaling bicycle communication system when the remaining distance is calculated to be 17.5 meters.

FIG. 13 is a perspective view of the slave module of the automatic light signaling bicycle communication system in the second embodiment of the present invention.

FIG. 14 is a perspective view of the slave module of the automatic light signaling bicycle communication system in another embodiment of the present invention.

### DETAILED DESCRIPTION OF THE INVENTION

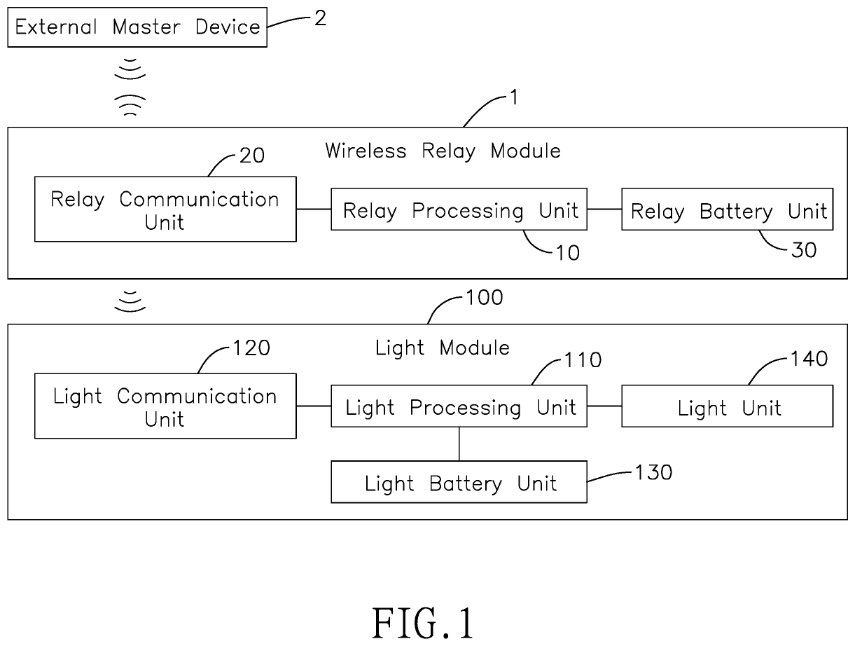

With reference to FIG. 1, the present invention provides an automatic light signaling bicycle communication system. The automatic light signaling bicycle communication system includes a wireless relay module 1 and a light module 100, and an external master device 2 works in cooperation with the automatic light signaling bicycle communication system of the present invention.

The wireless relay module 1 includes a relay processing unit 10, a relay communication unit 20, and a relay battery unit 30. The relay processing unit 10 is electrically connected to the relay communication unit 20 and the relay battery unit 30 respectively. The relay communication unit 20 is wirelessly connected to the external master device 2. The relay processing unit 10 controls the relay communication unit 20 to wirelessly communicate with the external master device 2 according to a network protocol. The relay battery unit 30 holds a battery charge for the wireless relay module 1.

The light module 100 includes a light processing unit 110, a light communication unit 120, a light battery unit 130, and a light unit 140. The light processing unit 110 is electrically connected to the light communication unit 120, the light battery unit 130, and the light unit 140 respectively. The wireless relay module 1 and the light module 100 are respectively mounted on a bicycle.

The external master device 2 is a smart device installed with an application (APP). The external master device 2 is also equipped with a GPS receiver, and the external master device 2 uses the GPS receiver to obtain a motion information of the external master device 2. The motion information includes an acceleration information and a direction information. The acceleration information relates to an acceleration of the external master device 2, and the direction information relates to a direction the external master device 2 faces. In a first embodiment of the present invention, the external master device 2 is a smart phone. In other embodiments, the external master device 2 is the smart device such as a mobile phone, a tablet computer, or a smart watch.

When the external master device 2 determines the external master device 2 is slowing down according to the motion information, the external master device 2 generates a brake command and sends the brake command to the relay processing unit 10. The external master device 2 determines the external master device 2 is slowing down when the external master device 2 determines that the acceleration of the external master device 2 is negative according to the acceleration information. Vice versa, the external master device 2 determines the external master device 2 is speeding up when the external master device 2 determines that the acceleration of the external master device 2 is positive according to the acceleration information. The external master device 2 determines the external master device 2 is stationary when the external master device 2 determines that the acceleration of the external master device 2 is zero according to the acceleration information.

When the relay processing unit 10 receives the brake command through the relay communication unit 20, the relay processing unit 20 generates a relay brake command and broadcasts the relay brake command to the light communication unit 120 of the light module 100 through the relay communication unit 20 according to a media access control (MAC) protocol.

When the light processing unit 110 receives the relay brake command through the light communication unit 120 of the light module 100, the light processing unit 110 controls the light unit 140 to light up according to the relay brake command.

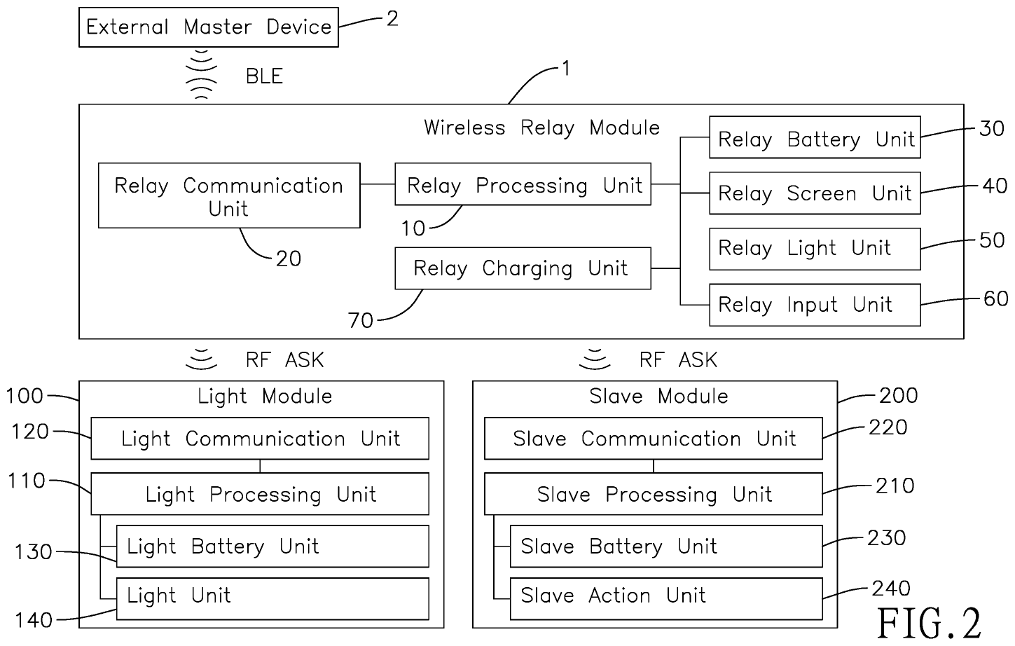

With reference to FIG. 2, in a first embodiment of the present invention, the relay communication unit 20 of the wireless relay module 1 broadcasts commands not only to the light communication unit 120 of the light module 100, but also broadcasts to a slave communication unit 220 of a slave module 200. The slave module 200 includes a slave processing unit 210, the slave communication unit 220, a slave battery unit 230, and a slave action unit 240. The slave processing unit 210 is connected to the slave communication unit 220, the slave battery unit 230, and the slave action unit 240 respectively.

When the relay processing unit 10 receives a command generated by the external master device 2 through the relay communication unit 20 according to the network protocol, the relay processing unit 10 generates a relay command and broadcasts the relay command to the slave communication unit 220 of the slave module 200 through the relay communication unit 20 according to the MAC protocol. When the slave processing unit 210 receives the relay command through the slave communication unit 220 of the slave module 200, the slave processing unit 210 controls the slave action unit 240 to execute an action relating to the bicycle according to the relay command.

The wireless relay module 1 communicates with the external master device 2 with Bluetooth Low Energy (BLE). The wireless relay module 1 broadcasts to all modules under the wireless relay module 1, in other words, the wireless relay module 1 broadcasts to both the light module 100 and the slave module 200 in this embodiment with radio frequency (RF) generated with on-off keying (OOK), amplitude-shift keying (ASK), or Frequency-Shift keying (FSK). For example, when a last bit is zero, then a new logic starts with a higher voltage level; when a last bit is one, then a new logic starts with a lower voltage level. In a one-millisecond (ms) duration to determine the new logic for a next bit, when the higher voltage level or the lower voltage level remains unchanged, then the next bit is determined as one, and when the higher voltage level is flipped to be the lower voltage level or when the lower voltage level is flipped to be the higher voltage level, the next bit is then determined as zero. This is an example of how data packages are broadcasted at a frequency of 433 megahertz (MHz), at a data speed of 2 thousand bits per second (2 k bps), with each data package taking about 15.5 ms. The wireless relay module 1 broadcasts a same relay command for 20 times, which takes about 15.5 ms*20=310 ms of broadcasting time for the relay command.

A pairing process is a process for all slave modules, such as the light module 100 and the slave module 200, intended to receive broadcasts from the wireless relay module 1 to be respectively paired with the wireless relay module 1. The light module 100 and the slave module 200 each respectively have a close to unique ID address generated during the pairing process for receiving specific broadcasts dedicated to them. For example, when the external master device 2 generates and sends the brake command to the wireless relay module 1, the wireless relay module 1 generates and broadcasts the relay brake command to both the light module 100 and the slave module 200. However, since the relay brake command includes information of the ID address of the light module 100 only, only the light module 100 would accept the brake command with the matching ID address, and therefore only the light module 100 would follow the relay brake command to execute the action of lighting up the light unit 140.

Similarly, when the external master device 2 generates and sends the command to the wireless relay module 1, the wireless relay module 1 generates and broadcasts the relay command to both the light module 100 and the slave module 200. However, depending on the ID addresses coded in the command, only modules with the matching ID addresses would be commanded to execute the action.

This selectiveness of the ID address specified in the relay command generated by the wireless relay module 1 allows all modules to be controlled in a network fashion. In other words, the wireless relay module 1 relays commands generated by the external master device 2 in a one-way fashion to all modules. Despite the one-way RF broadcast is considered technology of a Layer 2: Data link layer in an Open System Interconnection Model (OSI model), the present invention actually allows the light module 100 and the slave module 200 to be controlled as if having technology of a Layer 3 Network Layer in the OSI model. This is because communicated commands between the external master device 2 and the wireless relay module 1 over the BLE network are easily relayed and converted into equivalent commands in RF signals for broadcasting. The present invention is able to add new modules or remove modules from a receiving end of the broadcast by configuring the ID addresses acknowledged by the wireless relay module 1. Only the ID addresses acknowledged by the wireless relay module 1 would enter and be included in the network for a possibility of receiving the relay command to execute the action.

Furthermore, the external master device 2 is able to generate a configuration command as the command to the relay processing unit 10 of the wireless relay module 1 through the relay communication unit 20. When the relay processing unit 10 of the wireless relay module 1 receives the configuration command, the relay processing unit 10 generates the relay command as the configuration command and broadcasts the relay command to the slave communication unit 220 of the slave module 200 through the relay communication unit 20. When the slave processing unit 210 receives the relay command through the slave communication unit 220 of the slave module 200, the slave processing unit 210 configures the slave action unit 240 according to the relay command as the action.

For example, in this embodiment, the slave module 200 is a brake of the bicycle. The slave action unit 240 is a sensitivity control unit of the brake of the bicycle. When the external master device 2 generates a raise sensitivity command as the command, the external master device 2 sends the command to the relay processing unit 10. The relay processing unit 10 then relays the raise sensitivity command as the relay command to the sensitivity control unit of the brake of the bicycle. The slave processing unit 210 controls the slave action unit 240 to raise sensitivity of the brake according to the raise sensitivity command. In this case, raising sensitivity of the brake is configuring the sensitivity control unit of the brake of the bicycle.

On the other hand, when the external master device 2 generates a lower sensitivity command as the command, the external master device 2 sends the command to the relay processing unit 10. The relay processing unit 10 relays the lower sensitivity command as the relay command to the sensitivity control unit of the brake of the bicycle. The slave processing unit 210 controls the slave action unit 240 to lower sensitivity of the brake according to the lower sensitivity command.

Furthermore, the external master device 2 generates a control list inquiry command to the relay processing unit 10 of the wireless relay module 1 through the relay communication unit 20. When the relay processing unit 10 of the wireless relay module 1 receives the control list inquiry command, the relay processing unit 10 returns a control list information to the external master device 2 through the relay communication unit 20, acquiring a list of ID addresses of all modules being acknowledged by the wireless relay module 1. In this embodiment, all modules mean the light module 100 and the slave module 200.

The external master device 2 is able to generate a charge inquiry command to the relay processing unit 10 of the wireless relay module 1 through the relay communication unit 20. When the relay processing unit 10 of the wireless relay module 1 receives the charge inquiry command, the relay processing unit 10 returns a battery charge information to the external master device 2, signifying a state of charge of the battery charge of the relay battery unit 30.

As shown in FIG. 2, in the present embodiment, the wireless relay module 1 further includes a relay screen unit 40, a relay light unit 50, a relay input unit 60, and a relay charging unit 70. The relay screen unit 40, the relay light unit 50, the relay input unit 60, and the relay charging unit 70 are all respectively connected to the relay processing unit 10.

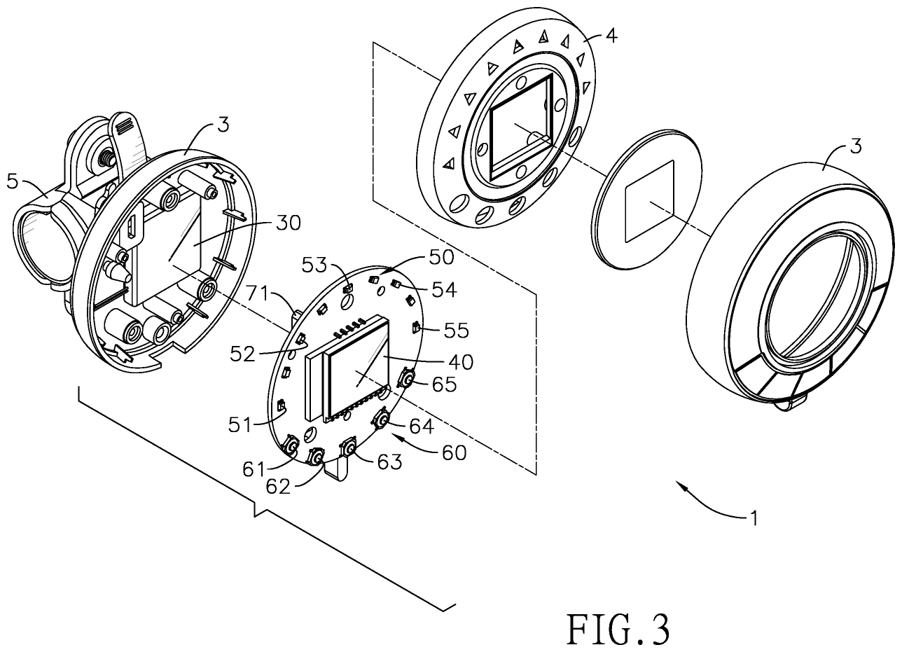

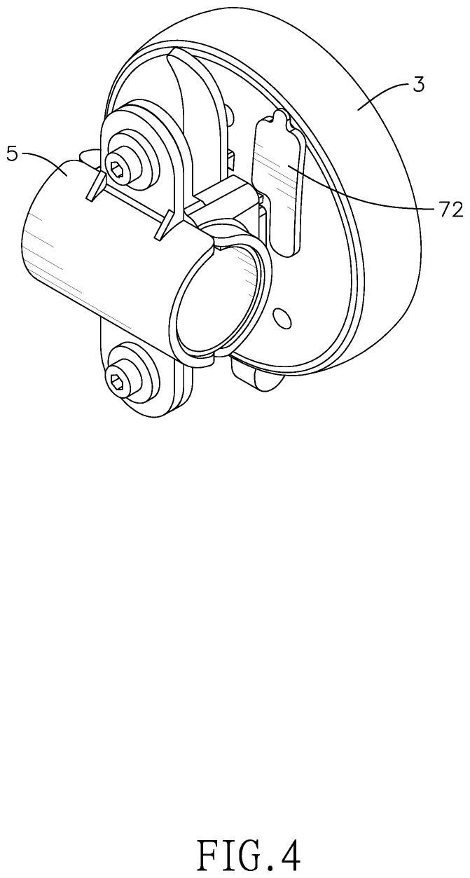

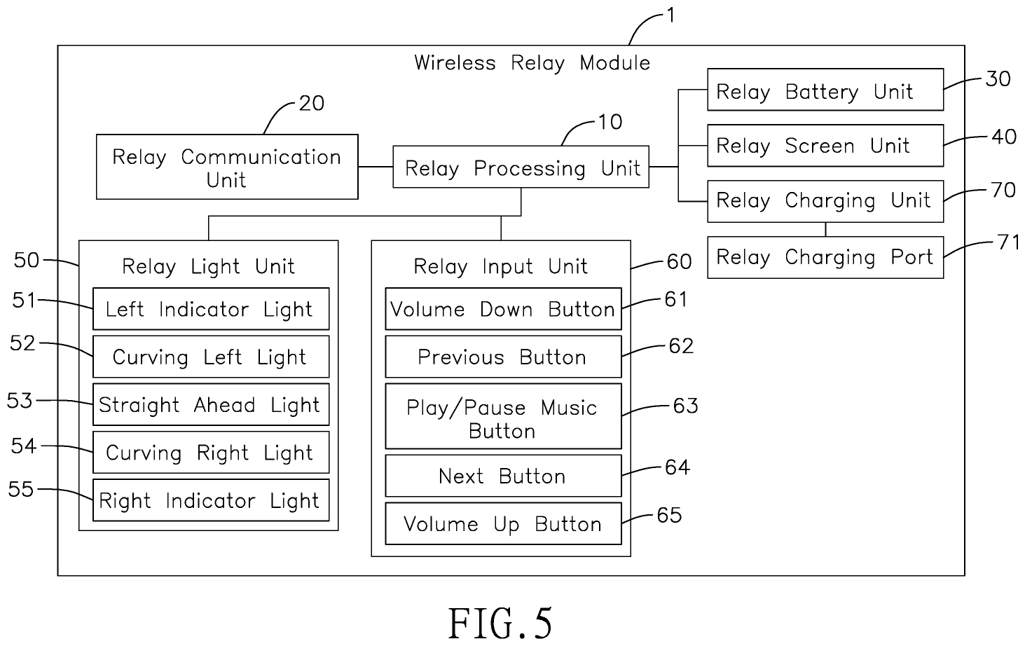

With reference to FIGS. 3 to 5, the wireless relay module 1 includes an outer shell 3, an inner shell 4, and a holder 5. The holder 5 is connected to the outer shell 3, and the outer shell 3 covers the inner shell 4. The holder 5 holds on to a stem of the bicycle. The inner shell 4 and the outer shell 3 enclose the relay battery unit 30, the relay screen unit 40, the relay light unit 50, and the relay input unit 60.

More particularly, the relay light unit 50 includes a left indicator light 51, a curving left light 52, a straight ahead light 53, a curving right light 54, and a right indicator light 55. The relay input unit 60 includes a volume down button 61, a previous button 62, a play/pause music button 63, a next button 64, and a volume up button 65. The inner shell 4 and the outer shell 3 are circular.

The left indicator light 51, the curving left light 52, the straight ahead light 53, the curving right light 54, and the right indicator light 55 of the relay light unit 50 are arranged in an arc, with the straight ahead light 53 in the middle, the left indicator light 51 in the far left of the arc, and the right indicator light 55 in the far right of the arc. The volume down button 61, the previous button 62, the play/pause music button 63, the next button 64, and the volume up button 65 of the relay input unit 60 are also arranged in another arc, wherein the play/pause music button 63 is located in the middle between the previous button 62 and the next button 64. The relay screen unit 40 is located between the relay light unit 50 and the relay input unit 60.

The inner shell 4 includes multiple holes in corresponding locations of the relay screen unit 40, the relay light unit 50, and the relay input unit 60, allowing the relay screen unit 40, the relay light unit 50, and the relay input unit 60 to shine through. The outer shell 3 also includes a hole for the relay screen unit 40 to shine through, as well as transparent plastic parts allowing the relay light unit 50 and the relay input unit 60 to shine through.

The outer shell 3 also includes a hole covered with a dust cover 72 for a relay charging port 71. The relay charging port 71 is connected to the relay charging unit 70. When the relay charging port 71 is connected to a charging wire, for example a Universal Serial Bus (USB) charging wire or a lightening charging wire, the relay charging port 71 receives charging electricity. When the relay charging unit 70 receives charging electricity through the relay charging port 71, and a state of charge of the relay battery unit 30 is less than 100%, the relay processing unit 70 generates a charging information, and sends the charging information to the external master device 2 through the relay communication unit 20.

When the relay charging unit 70 receives charging electricity through the relay charging port 71, and the state of charge of the relay battery unit 30 is equal to 100%, the relay processing unit 70 generates a fully charged information, and sends the fully charged information to the external master device 2 through the relay communication unit 20. After receiving the charging information or the fully charged information, the external master device 2 displays the charging information or the fully charged information correspondingly, both on the external master device 2 and on the relay screen unit 40 through the relay communication unit 20 and the relay processing unit 10.

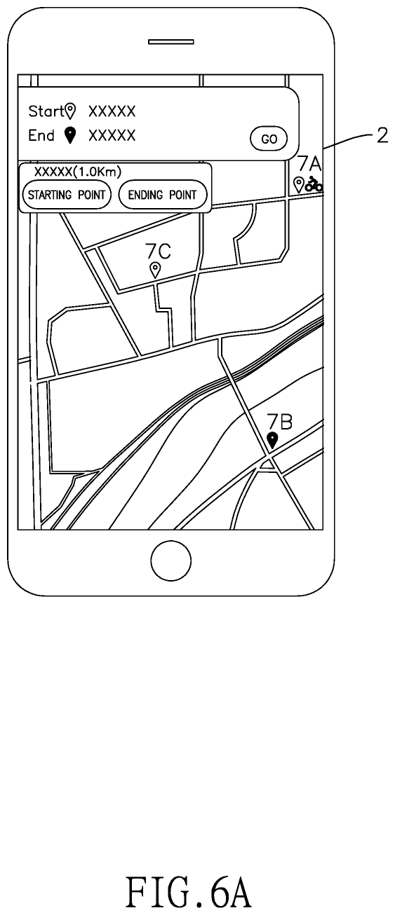

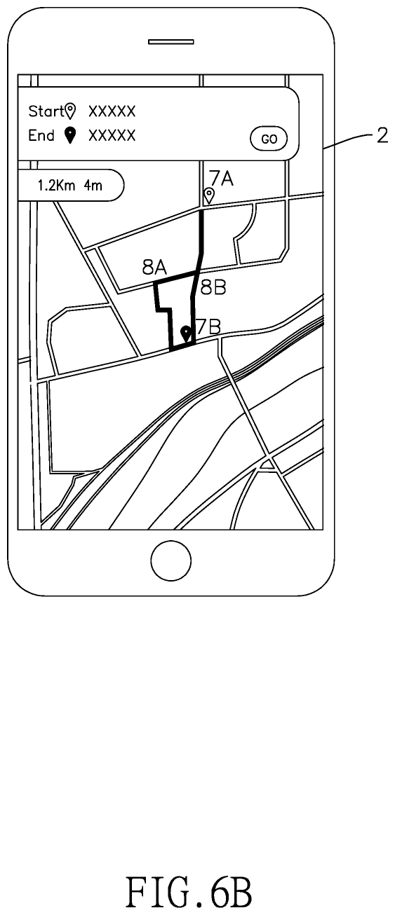

With reference to FIGS. 6A and 6B, the external master device 2 uses an online navigation source, such as Google Map, to set up a confirmed navigation route between a starting point 7A and an ending point 7B within the APP. As shown in FIG. 6A, while setting up the starting point 7A and the ending point 7B through the APP in the external master device 2, the starting point 7A and the ending point 7B can be easily modified by selecting a new point 7C as an updated starting point or an updated ending point.

As shown in FIG. 6B, once the starting point 7A and the ending point 7B are settled, the APP in the external master device 2, through information obtained from the online navigation source, generates at least one possible navigation route, such as route 8A or route 8B displayed in FIG. 6B. One of the at least one route would then be selected as the confirmed navigation route for navigation. The present invention assumes a user is both the bicycle rider and the owner of the smart phone, therefore the present invention assumes the external master device 2 travels with the user riding the bicycle.

The external master device 2 further uses the motion information obtained through the GPS receiver and a location data that the external master device 2 receives through the online navigation source to navigate along the confirmed navigation route with a current position of the external master device 2, which is assumed to also be the current position of the bicycle and the user.

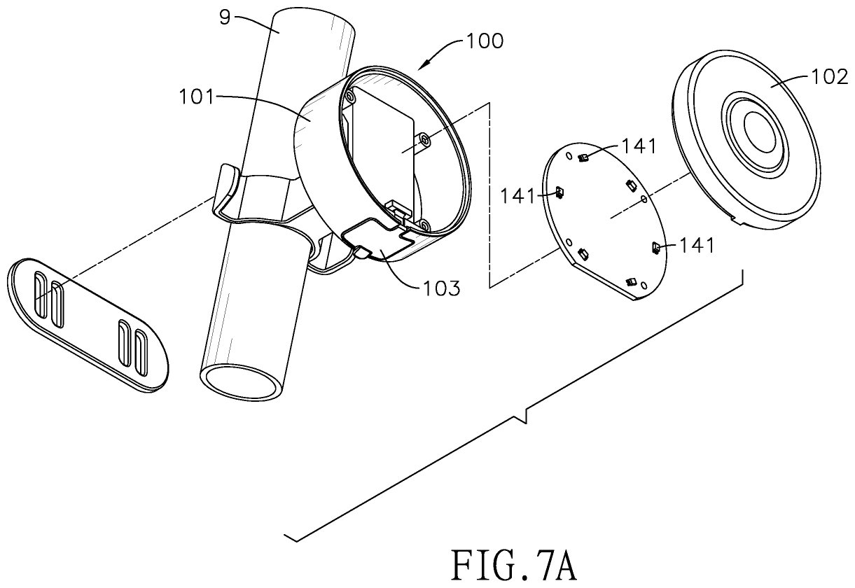

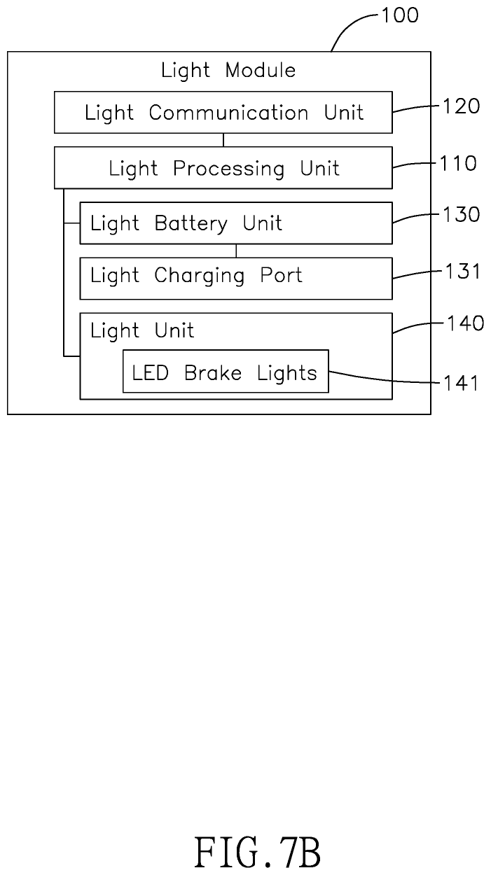

With reference to FIGS. 7A and 7B, in the current embodiment, the light module 100 of the bicycle is mounted on a tube 9 of the bicycle. The light unit 140 includes multiple LED brake lights 141 arranged in a ring shape. The light module 100 along with the LED brake lights 141 are covered by a brake light shell 101 and a transparent brake light shield 102. The brake light shell 101 further includes a hole with a dust cover 103. The dust cover 103 covers a light charging port 131, and the light charging port 131 is electrically connected to the light battery unit 130.

When the external master device 2 determines the external master device 2 is slowing down according to the motion information, the external master device 2 generates the brake command and sends the brake command to the relay processing unit 10. When the light module 100 of the bicycle receives the relay brake command, the light processing unit 110 controls the LED brake lights 141 of the light unit 140 to light up according to the relay brake command. When the external master device 2 determines the external master device 2 is speeding up or keeping speed, then the LED brake lights 141 of the light unit 140 stop lighting up.

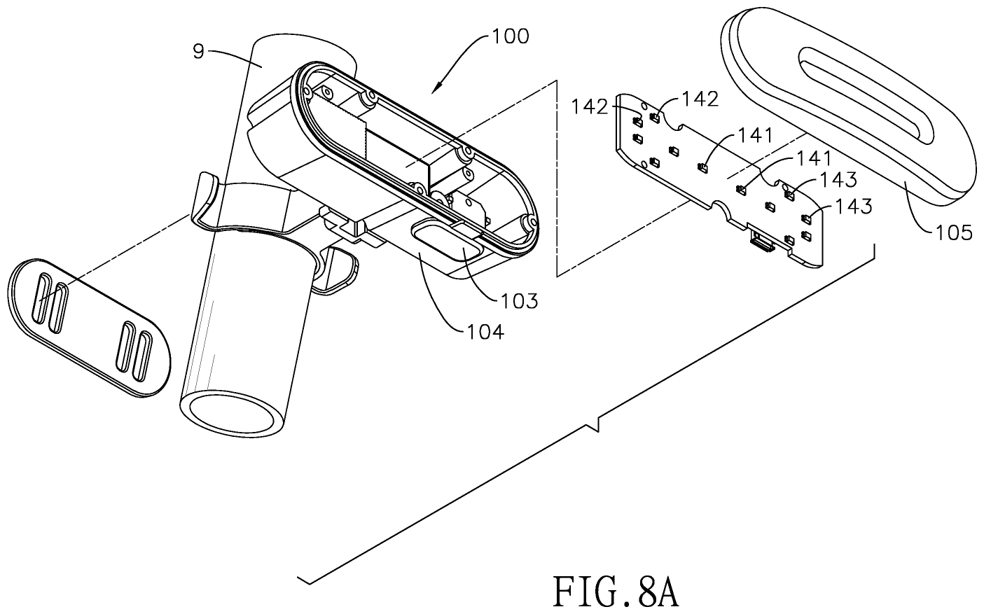

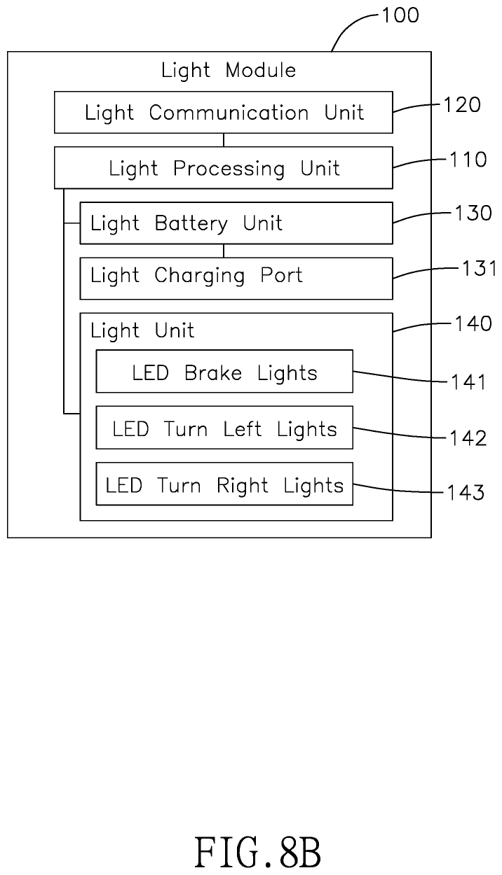

With reference to FIGS. 8A and 8B, in a second embodiment of the present invention, the light module 100 of the bicycle is also mounted on the tube 9 of the bicycle. The light unit 140 includes multiple LED brake lights 141, multiple LED turn left lights 142, and multiple LED turn right lights 143. The LED brake lights 141 are located between the LED turn left lights 142 and the LED turn right lights 143. The light module 100 along with the LED turn left lights 142, the LED brake lights 141, and the LED turn right lights 143 are covered by a light shell 104 and a transparent light shield 105.

The command generated by the external master device 2 and the relay command generated by the relay processing unit 10 are turn signal commands.

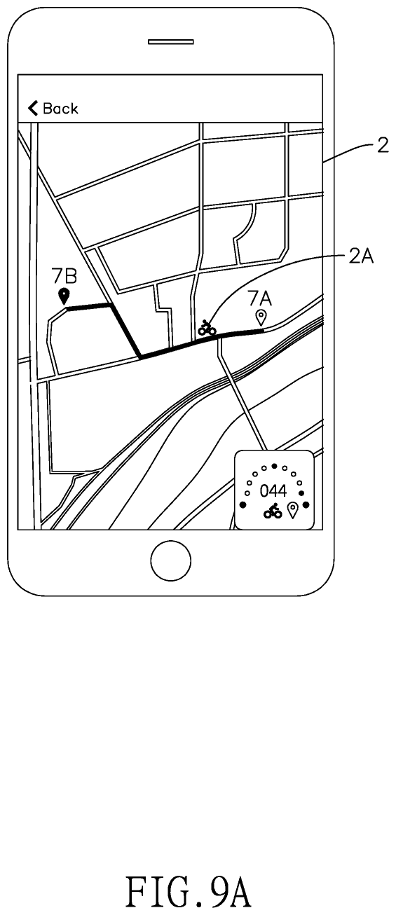

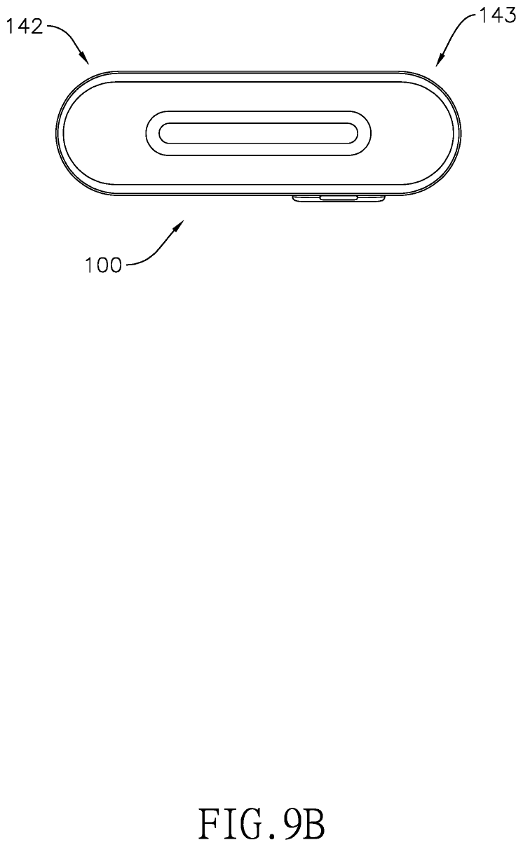

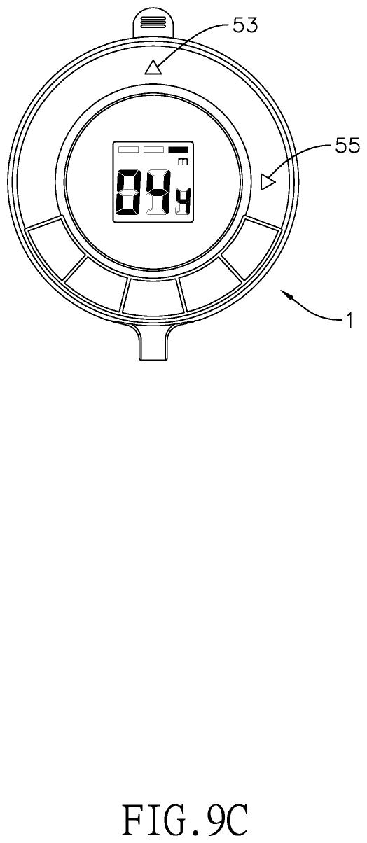

With reference to FIGS. 9A, 9B, and 9C, in an example for this embodiment, a bicycle icon 2A in the APP displayed from the external master device 2 is moving along the confirmed navigation route. The command generated by the external master device 2 is thus the turn signal command generated according to the current position of the external master device 2 along the confirmed navigation route.

The external master device 2 calculates a remaining distance from the current position of the external master device 2 to a next turn according to the confirmed navigation route, a current speed of the bicycle, and a total remaining distance from the current position of the external master device to the ending point according to the confirmed navigation route. The external master device 2 then displays the remaining distance through a screen of the external master device 2 on the APP, and the external master device 2 then transmits the remaining distance to the wireless relay module 1. When the relay processing unit 10 of the wireless relay module 1 receives the remaining distance generated by the external master device 2, the relay processing unit 10 controls the relay screen unit 40 to display the remaining distance. In FIGS. 9A and 9C, the remaining distance is calculated by the external master device 2 as 4.4 meters (m), and thus both the external master device 2 and the relay screen unit 40 display “044” signifying 4.4 m.

The external master device 2 further determines whether the next turn is a right turn or a left turn. The external master device also stores a first turn threshold distance, a second turn threshold distance, a first frequency information, and a second frequency information. The second turn threshold distance is less than the first turn threshold distance. In the present embodiment, the first turn threshold distance is 4.0 m, and the second turn threshold distance is 2.0 m.

After the external master device 2 calculates the remaining distance, the external master device 2 determines whether the remaining distance is less than or equal to the first turn threshold distance.

When the external master device 2 determines the remaining distance is greater than the first turn threshold distance, the external master device 2 is yet to send out a turn right signal command or a turn left signal command with the first frequency information to the relay processing unit 10 of the wireless relay module 1. In this example, since the remaining distance is 4.4 m, and 4.4 m is greater than 4.0 m, the LED turn right lights 143 of the light module 100 of the bicycle is yet to light up, as shown in FIG. 9B. However, since the external master device 2 determines the next turn to be a right turn for the bicycle icon 2A along the confirmed navigation route, the external master device 2 controls the right indicator light 55 of the relay light unit 50 to light up, hinting the user that the next stop would be a right turn, as shown in FIG. 9C. Furthermore, the straight ahead light 53 also lights up because the external master device 2 is traveling straight towards the next turn.

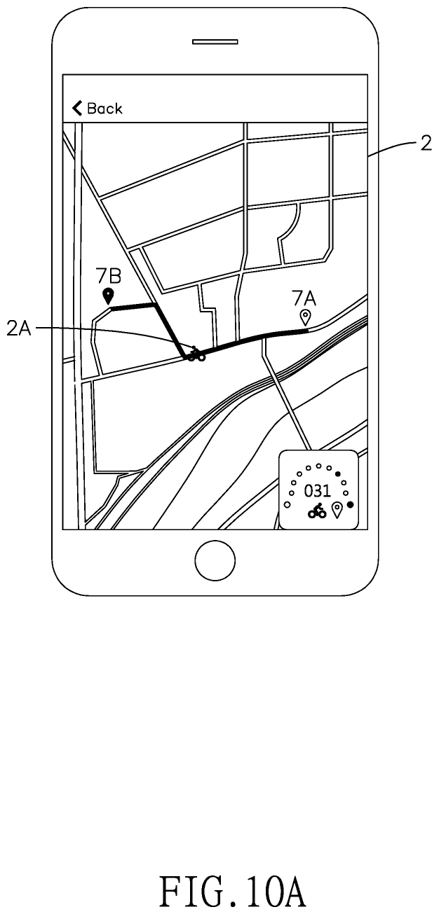

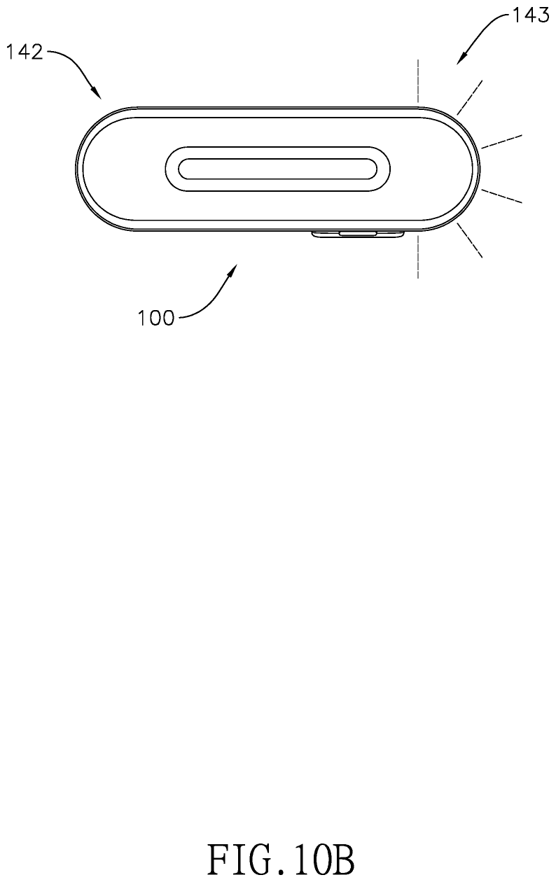

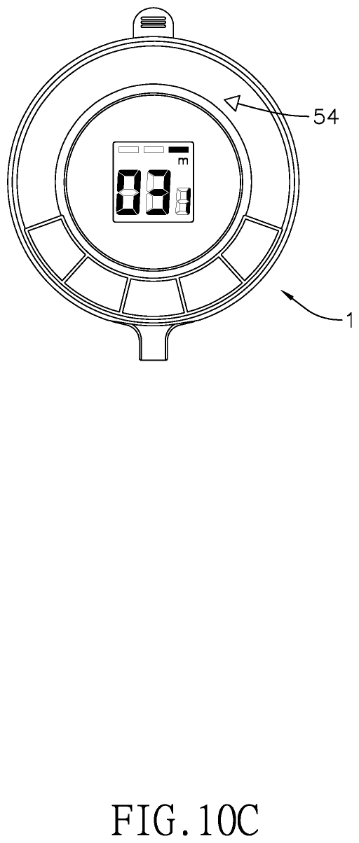

With reference to FIGS. 10A, 10B, and 10C, when the external master device 2 determines the remaining distance is less than or equal to the first turn threshold distance, the external master device 2 sends out the turn right signal command or the turn left signal command with the first frequency information to the relay processing unit 10 of the wireless relay module 1. When the relay processing unit 10 of the wireless relay module 1 receives the turn right signal command or the turn left signal command with the first frequency information, the relay processing unit 10 broadcasts the turn right signal command or the turn left signal command with the first frequency information, and the light processing unit 110 accordingly controls the LED turn right lights 143 or the LED turn left lights 142 of the light module 100 to blink at a first frequency.

In this case, since the remaining distance is 3.1 m, displayed as “031” in both FIGS. 10A and 10C, and that 3.1 m is less than 4.0 m, and the next turn is a right turn, the LED turn right lights 143 of the light module 100 light up as depicted in FIG. 10B.

In other words, when the external master device 2 determines the external master device 2 is approaching a right turn along the confirmed navigation route, the external master device 2 generates the command as the turn right signal command, and accordingly, the LED turn right lights 143 of the light module 100 of the bicycle light up. When the external master device 2 determines the external master device 2 is approaching a left turn along the confirmed navigation route, the external master device 2 generates the command as the turn left signal command, and accordingly, the LED turn left lights 142 of the light module 100 of the bicycle light up.

The external master device 2 further determines whether the remaining distance is less than or equal to the second turn threshold distance. When the external master device 2 determines the remaining distance is greater than the second turn threshold distance, the external master device 2 is yet to change the blinking frequency of the light module 100. In this example, since the remaining distance 3.1 m is greater than 2.0 m, the LED turn right lights 143 of the light module 100 blink at the first frequency instead of the second frequency.

Furthermore, the curving right light 54 also lights up, because a relative position of the next turn to the external master device 2 has changed. In other words, when the external master device 2 and the bicycle are closely approaching the next turn, the navigation route at the next turn would be curving either right or left from the current position of the external master device 2. This curving direction is dynamically displayed through the relay light unit 50 of the wireless relay module 1, and in this case, the curving right light 54 lights up because the navigation route at the next turn is slightly curving towards the right side.

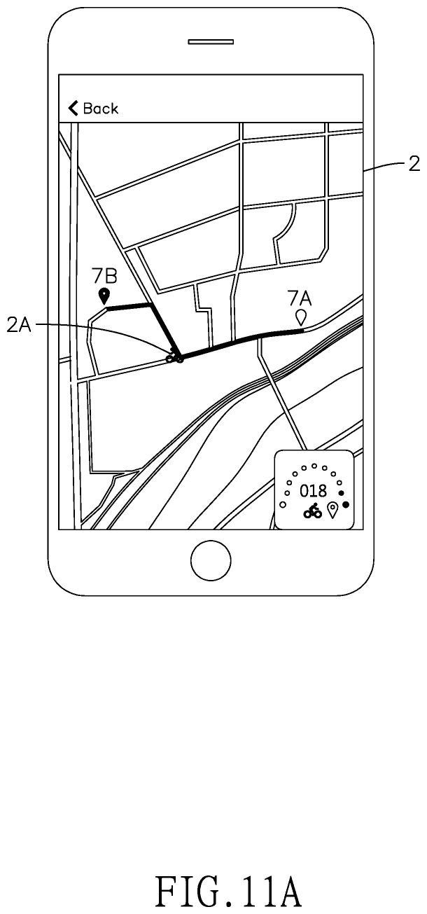

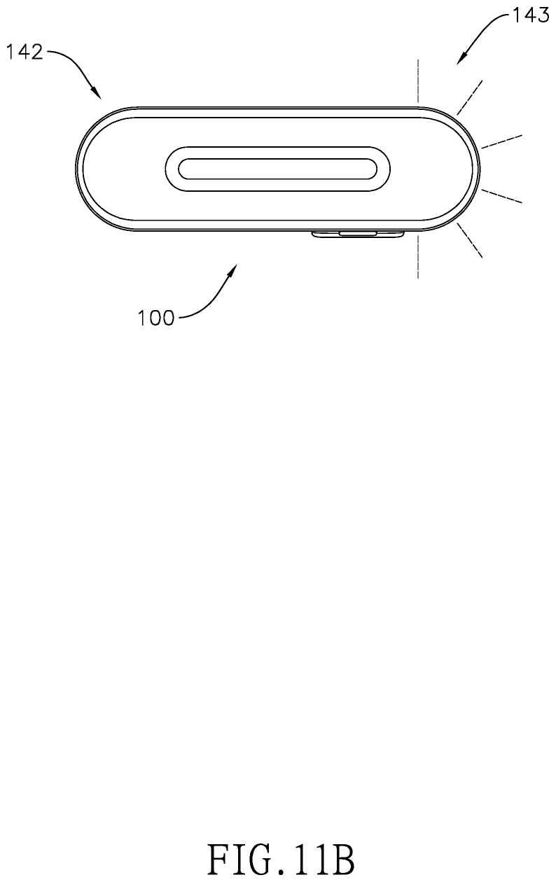

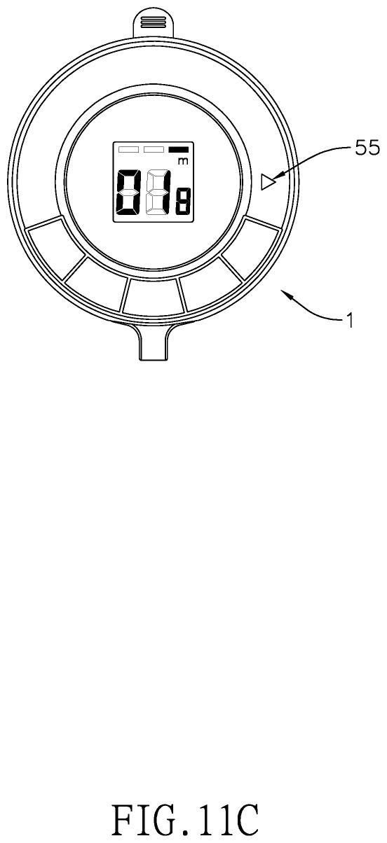

With reference to FIGS. 11A, 11B, and 11C, when the external master device 2 determines the remaining distance is less than or equal to the second turn threshold distance, the external master device 2 sends out the turn right signal command or the turn left signal command with the second frequency information to the relay processing unit 10 of the wireless relay module 1. When the relay processing unit 10 of the wireless relay module 1 receives the turn right signal command or the turn left signal command with the second frequency information, the relay processing unit 10 broadcasts the turn right signal command or the turn left signal command with the second frequency information, and the light processing unit 110 accordingly controls the LED turn right lights 143 or the LED turn left lights 142 of the light module 100 to blink at a second frequency. The second frequency is higher than the first frequency.

In this case, since the remaining distance is 1.8 m, the external master device 2 and the relay screen unit 40 accordingly display “018” signifying the remaining distance to the user. Since the remaining distance 1.8 m is less than 2.0 m, the LED turn right lights 143 of the light module 100 blink at the second frequency instead of the first frequency. In this embodiment, the first frequency is such that for every 500 ms, or 0.5 second (s), the LED turn right lights 143 of the light module 100 light up, and then for another 500 ms, the LED turn right lights 143 of the light module 100 stop lighting up. Furthermore, the second frequency is such that for every 100 ms, or 0.1 s, the LED turn right lights 143 of the light module 100 light up, and then for another 100 ms, the LED turn right lights 143 of the light module 100 stop lighting up.

When the wireless relay module 1 receives the turn right signal command, the wireless relay module 1 controls the relay light unit 50 to light up the right indicator light 55. When the wireless relay module 1 receives the turn left signal command, the wireless relay module 1 controls the relay light unit 50 to light up the left indicator light 51.

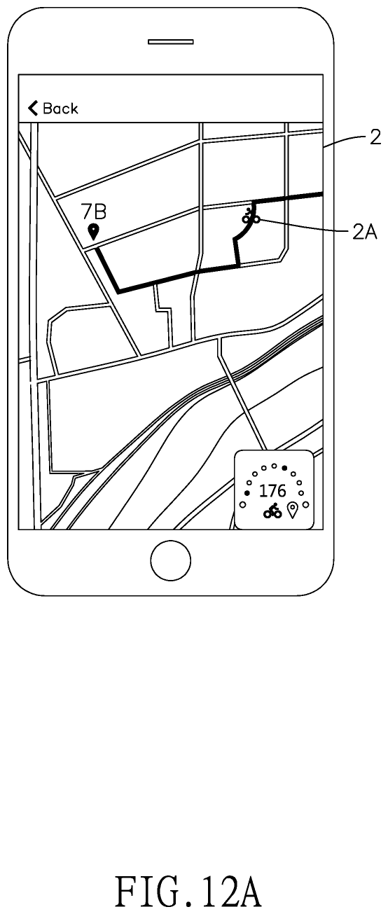

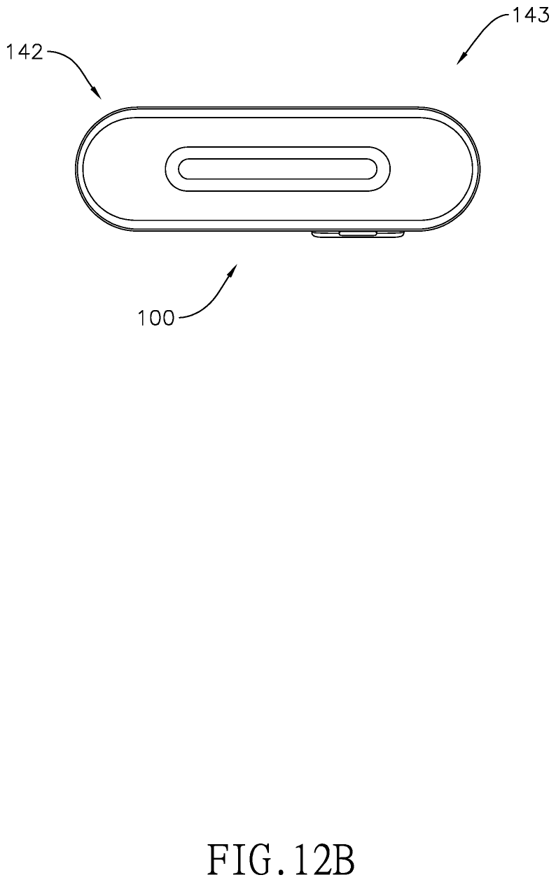

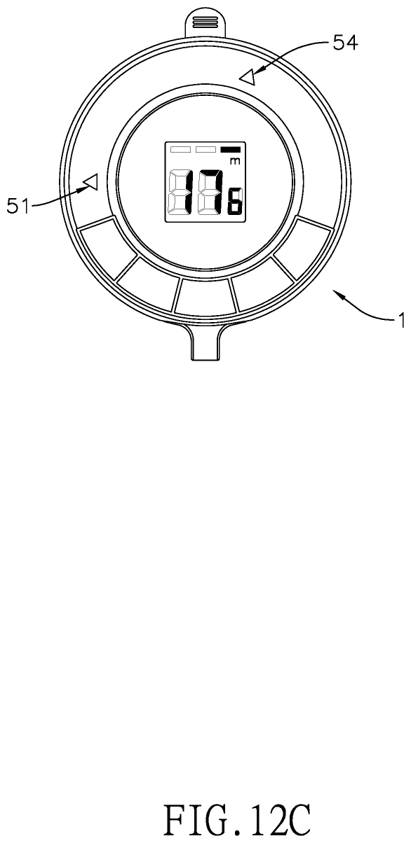

With reference to FIGS. 12A, 12B, and 12C, the external master device 2 determines whether the external master device 2 is traveling straight along the confirmed navigation route, curving right along the confirmed navigation route, or curving left along the navigation route.

When the external master device 2 is traveling straight along the confirmed navigation route, the external master device 2 generates a straight ahead signal command and sends the straight ahead signal command to the wireless relay module 1. When the wireless relay module receives the straight ahead signal command, the wireless relay module 1 controls the relay light unit 50 to light up the straight ahead light 53.

When the external master device 2 is curving right along the confirmed navigation route, the external master device 2 generates a curving right signal command and sends the curving right signal command to the wireless relay module 1. When the wireless relay module 1 receives the curving right signal command, the wireless relay module 1 controls the relay light unit 50 to light up the curving right light 54.

When the external master device 2 is curving left along the confirmed navigation route, the external master device 2 generates a curving left signal command and sends the curving left signal command to the wireless relay module 1. When the wireless relay module 1 receives the curving left signal command, the wireless relay module 1 controls the relay light unit 50 to light up the curving left light 52.

As shown in FIG. 12A, the bicycle icon 2A is traveling down a curvy road, more particularly, the external master device 2 is curving right along the confirmed navigation route towards a left turn as the next turn. Therefore, the curving right light 54 and the left indicator light 51 are lighting up in FIG. 12C. Since the remaining distance to the next turn is greater than the first threshold, the LED turn left lights 142 of the light module 100 are yet to light up in FIG. 12B.

Furthermore, as a smart phone, the external master device 2 is also capable of playing music through the APP.

When the play/pause music button 63 is triggered, the relay input unit 60 generates a play/pause music signal to the relay processing module 10. The relay processing module 10 then sends a play/pause music command to the external master device 2. When the external master device 2 receives the play/pause music command, the external master device 2 plays/pauses music through the APP.

When the volume up button 65 is triggered, the relay input unit 60 generates a volume up signal to the relay processing module 10. The relay processing module 10 then sends a volume up command to the external master device 2. When the external master device 2 receives the volume up command, the external master device 2 increases volume of music through the APP.

When the volume down button 61 is triggered, the relay input unit 60 generates a volume down signal to the relay processing module 10. The relay processing module 10 then sends a volume down command to the external master device 2. When the external master device 2 receives the volume down command, the external master device 2 decreases volume of music through the APP.

When the next button 64 is triggered, the replay input unit 60 generates a next signal to the relay processing module 10. The relay processing module 10 then sends a next command to the external master device 2. When the external master device 2 receives the next command, the external master device 2 determines whether the external master device 2 receives the next command greater than or equal to a long press time.

When the external master device 2 receives the next command less than the long press time, the external master device 2 changes music to next song through the APP.

When the external master device 2 receives the next command more than or equal to the long press time, the external master device 2 changes the relay screen unit 40 to display the total remaining distance of the bicycle instead of the remaining distance to the next turn by generating a change display distance command from the external master device 2 to the relay processing unit 10.

When the previous button 62 is triggered, the replay input unit 60 generates a previous signal to the relay processing module 10. The relay processing module 10 then sends a previous command to the external master device 2. When the external master device 2 receives the previous command, the external master device 2 determines whether the external master device 2 receives the previous command greater than or equal to the long press time.

When the external master device 2 receives the previous command less than the long press time, the external master device 2 changes music to a previous song through the APP.

When the external master device 2 receives the previous command more than or equal to the long press time, the external master device 2 changes the relay screen unit 40 to display the current speed of the bicycle instead of the remaining distance by generating a change display speed command from the external master device 2 to the relay processing unit 10.

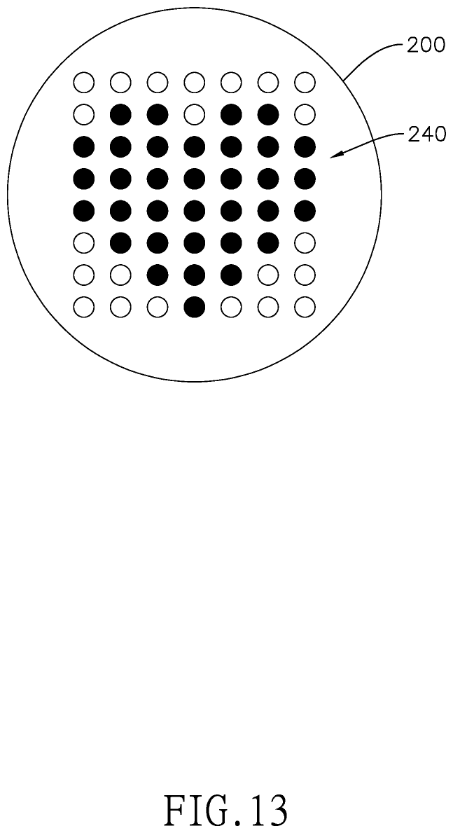

With reference to FIG. 13, in another embodiment, the slave module 200 is a light panel. The slave action unit 240 is a matrix of multiple equally spaced LED lights.

When the external master device 2 generates a display picture command as the command and a picture information of a picture file, the external master device 2 sends the command along with the picture information to the relay processing unit 10. The relay processing unit 10 then relays the display picture command as the relay command along with the picture information to the light panel. In this embodiment, the picture file stored in the external master device 2 is in one or more than one bitmap format, and the picture displayed by the slave action unit 240 of the slave module 200 is an animated icon, for example an animated emoji.

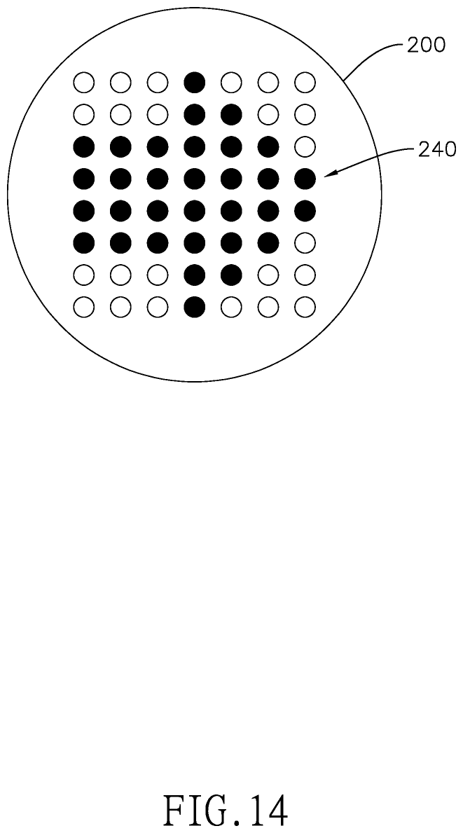

With reference to FIG. 14, in another embodiment of the present invention, the animated icon is equivalent of a turning light. In such case, the animated icon is an arrow pointing either left of the bicycle or right of the bicycle. The left pointing arrow would be displayed when approaching the next turn is a left turn, and the right pointing arrow would be displayed when approaching the next turn is a right turn, as shown in FIG. 14. In the context of the present invention, approaching means by having the remaining distance calculated and determined by the external master device 2 to be less than the first turn threshold. In this embodiment, such first turn threshold is 20 meters.

Furthermore, the slave processing unit 210 controls the slave action unit 240 to display the picture according to a display frequency information specified in the relay command. When the display frequency information specifies a display frequency higher than 1 Hertz (Hz), the slave processing unit 210 then controls the slave action unit 240 to display and blink the picture according to the display frequency. When the display frequency information specifies the display frequency lower than 1 Hz or equal to 1 Hz, the slave processing unit 210 then controls the slave action unit 240 to display the picture without blinking.

Furthermore, in this embodiment, the slave battery unit 230 has a battery saving function. The slave processing unit 210 of the slave module 200 has a duty cycle of 0.3, allowing the present invention to help conserve a state of charge of the slave battery unit 230. The duty cycle of 0.3 for the slave module 200 is such that for every 200 ms, the slave processing unit 210 only works for 60 ms, and is idle for 140 ms. When the slave module 200 is idle, the slave module 200 only uses minimal current from the slave battery unit 230. Since each of the data packages of any relay commands requires longer broadcasting time 200 ms, in other words, since the relay command requires 250 ms to broadcast, the slave communication unit 220 controlled by the slave processing unit 210 of the slave module 200 would always be able to receive the relay command despite being idle for 140 ms within every 200 ms. Once the slave communication unit 220 starts to receive the relay command, the slave module 200 would work continuously until the relay command is fully received before being idle again.

The present invention uses the wireless relay module 1 as a relay between the network protocol and the MAC protocol, therefore in reality, only a RF transmitter chip used in the wireless relay module 1 requires network communication ability, and a simple RF receiver chip used for the light processing unit 110 of the light module 100 is much cheaper in cost for just receiving the relay brake command. In other words, the present invention allows the light module 100 to be commanded in a manner as if the light module 100 exists with the external master device 2 on a Layer 3 Network Layer in the OSI model, wherein in fact the light communication unit 120 of the light module 100 only requires the simple RF receiver chip that is of low cost and is able to receive the relay brake command according to MAC protocol. The APP used by the external master device 2 is an interactive software interface for the user of the present invention. The wireless relay module 1 is a hardware interface for the user of the present invention, though the wireless relay module 1 functions mainly as an automatic cross-protocol command-relaying module for the present invention.

More generally speaking, the present invention allows the light module 100, the slave module 200, or any more amount of modules under the wireless relay module 1 to be commanded in a manner as if all modules communicate with the external master device 2 on a Layer 3 Network Layer in the OSI model.

Furthermore, the present invention uses the external master device 2 to generate the brake command and the command. The wireless relay module 1 only relays the brake command and the command respectively as the relay brake command and the relay command to the light module 100 and the slave module 200. This means that, for the convenience and benefits of automatically signaling the light unit 140 when needed, the present invention makes use of an expensive chip in the external master device 2 to handle processing loads of determining when to generate the brake command, and the RF transmitter chip used in the wireless relay module 1 in comparison is much cheaper without needing to handle such processing loads. The processing loads can be, for example, calculating the remaining distance or locating the current position of the bicycle. This is why the wireless relay module 1 is primarily used as a relay, instead of a processor for navigation. This is an advantage for the present invention, as a manufacturing cost of the present invention is kept minimally low while satisfying the benefits of all of the aforementioned functions, such as automatic turn light signaling, brake light signaling, music playing, navigating, brake sensitivity adjusting, etc.

The user of the present invention is assumed to already own the smart device, the expensive chip used in the external master device 2 is considered pre-existing for the present invention, and therefore is omitted from being counted as part of the manufacturing cost for the present invention.

Since the RF transmitter chip used in the wireless relay module 1 is free from generating the brake light command, and since the simple RF receiver chip used in the light module 100 only requires an ability to receive the relay brake light command according to MAC protocol, a manufacturing cost or a modification cost of the bicycle is significantly decreased for the chips used in the wireless relay module 1 and the light module 100, and thus proves the inventiveness of the present invention. The present invention is able to lower the manufacturing cost or the modification cost of the bicycle for the functionality of controlling the light module and the slave device 200 in a network manner, and automatically signaling the light unit 140 of the light module 100 as well as controlling the slave action unit 240 to execute the action for the bicycle.

What is claimed is:

1. An automatic light signaling bicycle communication system, comprising:
an external master device;
a wireless relay module, comprising:
a relay processing unit;
a relay battery unit, electrically connecting to the relay processing unit;
a relay communication unit, electrically connecting to the relay processing unit;
wherein the relay processing unit controls the relay communication unit to wirelessly communicate with the external master device according to a network protocol;
a light module, comprising:
a light communication unit;
a light processing unit, electrically connecting to the light communication unit;
a light unit, electrically connecting to the light processing unit;
wherein when the relay processing unit receives a brake command through the relay communication unit from the external master device, the relay processing unit generates a relay brake command and broadcasts the relay brake command to the light communication unit of the light module through the relay communication unit according to a media access control (MAC) protocol; and
wherein when the light processing unit receives the relay brake command through the light communication unit of the light module, the light processing unit controls the light unit to light up according to the relay brake command.

2. The automatic light signaling bicycle communication system as claimed in claim 1, wherein:
the external master device is either a smart phone, a tablet computer, or a smart watch;
the external master device comprises a GPS (Global Positioning System) receiver and uses the GPS-receiver to obtain a motion information of the external master device; and
when the external master device determines the external master device is slowing down according to the motion information, the external master device generates the brake command and sends the brake command to the relay processing unit.

3. The automatic light signaling bicycle communication system as claimed in claim 1, further comprising:
a slave module, comprising:
a slave communication unit;
a slave processing unit, electrically connecting to the slave communication unit; and
a slave action unit, electrically connecting to the slave processing unit;
wherein when the relay processing unit receives a command generated by the external master device through the relay communication unit according to the network protocol, the relay processing unit generates a relay command and broadcasts the relay command to the slave communication unit of the slave module through the relay communication unit according to the MAC protocol; and
wherein when the slave processing unit receives the relay command through the slave communication unit of the slave module, the slave processing unit controls the slave action unit to execute an action according to the relay command.

4. The automatic light signaling bicycle communication system as claimed in claim 3, wherein:
the wireless relay module communicates with the external master device with Bluetooth Low Energy (BLE); and
the wireless relay module broadcasts to the light module and the slave module respectively with radio frequency (RF) generated with on-off keying (OOK), amplitude-shift keying (ASK), or frequency-shift keying (FSK).

5. The automatic light signaling bicycle communication system as claimed in claim 3, wherein:
when the relay processing unit of the wireless relay module receives a control list inquiry command generated by the external master device through the relay communication unit, the relay processing unit returns a control list information to the external master device, acquiring a list of ID addresses of all modules being acknowledged by the wireless relay module.

6. The automatic light signaling bicycle communication system as claimed in claim 3, wherein:
when the relay processing unit of the wireless relay module receives a charge inquiry command generated by the external master device through the relay communication unit, the relay processing unit returns a battery charge information to the external master device, signifying a state of charge of the relay battery unit.

7. The automatic light signaling bicycle communication system as claimed in claim 3, wherein:
when the relay processing unit of the wireless relay module receives a configuration command as the command generated by the external master device through the relay communication unit, the relay processing unit generates the relay command as the configuration command and broadcasts the relay command to the slave communication unit of the slave module; and
when the slave processing unit receives the relay command through the slave communication unit of the slave module, the slave processing unit configures the slave action unit according to the relay command as the action.

8. The automatic light signaling bicycle communication system as claimed in claim 3, wherein the wireless relay module further comprises:
a relay charging unit, electrically connecting the relay processing unit;
a relay charging port, electrically connecting the relay charging unit;
wherein when the relay charging unit receives charging electricity through the relay charging port, and a state of charge of the relay battery unit is less than 100%, the relay processing unit generates a charging information, and sends the charging information to the external master device through the relay communication unit; and
wherein when the relay charging unit receives charging electricity through the relay charging port, and the state of charge of the relay battery unit is equal to 100%, the relay processing unit generates a fully charged information, and sends the fully charged information to the external master device through the relay communication unit.

9. The automatic light signaling bicycle communication system as claimed in claim 3, wherein:
the light unit of the light module further comprises a turn right light and a turn left light; the turn right light and the turn left light respectively connect the light processing unit;
when the wireless relay module receives a turn right signal command generated by the external master device, the wireless relay module broadcasts the turn right signal command to the light module, and the turn right light of the light module accordingly lights up; and
when the wireless relay module receives a turn left signal command generated by the external master device, the wireless relay module broadcasts the turn left signal command to the light module, and the turn left light of the light module accordingly lights up.

10. The automatic light signaling bicycle communication system as claimed in claim 9, wherein the wireless relay module further comprises:
a relay screen unit, electrically connecting to the relay processing unit;
wherein when the relay processing unit of the wireless relay module receives a remaining distance generated by the external master device, the relay processing unit controls the relay screen unit to display the remaining distance.

11. The automatic light signaling bicycle communication system as claimed in claim 10, wherein:
the external master device stores a first turn threshold distance and a first frequency information;
the external master device determines whether the remaining distance is less than or equal to the first turn threshold distance;
when the external master device determines the remaining distance is greater than the first turn threshold distance, the external master device is yet to send out the turn right signal command or the turn left signal command with the first frequency information to the relay processing unit of the wireless relay module;
when the external master device determines the remaining distance is less than or equal to the first turn threshold distance, the external master device sends out the turn right signal command or the turn left signal command with the first frequency information to the relay processing unit of the wireless relay module; and
when the relay processing unit of the wireless relay module receives the turn right signal command or the turn left signal command with the first frequency information, the relay processing unit broadcasts the turn right signal command or the turn left signal command with the first frequency information, and the light processing unit accordingly controls the turn right light or the turn left light of the light module to blink at a first frequency.

12. The automatic light signaling bicycle communication system as claimed in claim 11, wherein:
the external master device stores a second turn threshold distance and a second frequency information; the second turn threshold distance is less than the first turn threshold distance;
the external master device further determines whether the remaining distance is less than or equal to the second turn threshold distance;
when the external master device determines the remaining distance is less than or equal to the second turn threshold distance, the external master device sends out the turn right signal command or the turn left signal command with the second frequency information to the relay processing unit of the wireless relay module;
when the relay processing unit of the wireless relay module receives the turn right signal command or the turn left signal command with the second frequency information, the relay processing unit broadcasts the turn right signal command or the turn left signal command with the second frequency information, and the light processing unit accordingly controls the turn right light or the turn left light of the light module to blink at a second frequency; and
the second frequency is higher than the first frequency.

13. The automatic light signaling bicycle communication system as claimed in claim 9, wherein the wireless relay module further comprises:
a relay light unit, electrically connecting to the relay processing unit;
wherein the relay light unit further comprises a left indicator light and a right indicator light;
when the wireless relay module receives the turn right signal command, the wireless relay module controls the relay light unit to light up the right indicator light; and
when the wireless relay module receives the turn left signal command, the wireless relay module controls the relay light unit to light up the left indicator light.

14. The automatic light signaling bicycle communication system as claimed in claim 13, wherein the relay light unit further comprises a straight ahead light, a curving left light, and a curving right light;
the external master device determines whether the external master device is traveling straight along a confirmed navigation route, curving right along the confirmed navigation route, or curving left along the navigation route;
when the external master device determines the external master device is traveling straight along the confirmed navigation route, the external master device generates a straight ahead signal command and sends the straight ahead signal command to the wireless relay module; when the wireless relay module receives the straight ahead signal command, the wireless relay module controls the relay light unit to light up the straight ahead light;
when the external master device determines the external master device is curving right along the confirmed navigation route, the external master device generates a curving right signal command and sends the curving right signal command to the wireless relay module; when the wireless relay module receives the curving right signal command, the wireless relay module controls the relay light unit to light up the curving right light; and
when the external master device determines the external master device is curving left along the confirmed navigation route, the external master device generates a curving left signal command and sends the curving left signal command to the wireless relay module; when the wireless relay module receives the curving left signal command, the wireless relay module controls the relay light unit to light up the curving left light.

15. The automatic light signaling bicycle communication system as claimed in claim 3, wherein the wireless relay module further comprises:
a relay input unit, electrically connecting the relay processing unit;
wherein the relay input unit further comprises a play/pause music button, a volume up button, and a volume down button;
wherein the external master device is capable of playing music;
when the play/pause music button is triggered, the relay input unit generates a play/pause music signal to the relay processing module; the relay processing module then sends a play/pause music command to the external master device; when the external master device receives the play/pause music command, the external master device plays/pauses music;
when the volume up button is triggered, the relay input unit generates a volume up signal to the relay processing module; the relay processing module then sends a volume up command to the external master device; when the external master device receives the volume up command, the external master device increases volume of music; and
when the volume down button is triggered, the relay input unit generates a volume down signal to the relay processing module; the relay processing module then sends a volume down command to the external master device; when the external master device receives the volume down command, the external master device decreases volume of music.

16. The automatic light signaling bicycle communication system as claimed in claim 15, wherein the relay input unit further comprises a next button and a previous button;
when the next button is triggered, the relay input unit generates a next signal to the relay processing module; the relay processing module then sends a next command to the external master device; when the external master device receives the next command, the external master device determines whether the external master device receives the next command greater than or equal to a long press time;
when the external master device determines the external master device receives the next command less than the long press time, the external master device changes music to next song;
when the previous button is triggered, the relay input unit generates a previous signal to the relay processing module; the relay processing module then sends a previous command to the external master device; when the external master device receives the previous command, the external master device determines whether the external master device receives the previous command greater than or equal to the long press time; and
when the external master device determines the external master device receives the previous command less than the long press time, the external master device changes music to a previous song.

17. The automatic light signaling bicycle communication system as claimed in claim 3, wherein
the wireless relay module further comprises a relay screen unit connecting to the relay processing unit; the external master device calculates a current speed, a remaining distance, and a total remaining distance; the external master device transmits the remaining distance to the wireless relay module; when the relay processing unit of the wireless relay module receives the remaining distance, the relay processing unit controls the relay screen unit to display the remaining distance;
when the external master device determines the external master device receives the next command more than or equal to the long press time, the external master device changes the relay screen unit to display the total remaining distance instead of the remaining distance to the next turn by generating a change display distance command from the external master device to the relay processing unit; and
when the external master device determines the external master device receives the previous command more than or equal to the long press time, the external master device changes the relay screen unit to display the current speed instead of the remaining distance by generating a change display speed command from the external master device to the relay processing unit.

18. The automatic light signaling bicycle communication system as claimed in claim 3, wherein:
the slave module is a light panel; the slave action unit is a matrix of multiple equally spaced LED lights;
when the external master device generates a display picture command as the command and a picture information of a picture file, the external master device sends the command along with the picture information to the relay processing unit;
the relay processing unit relays the display picture command as the relay command along with the picture information to the light panel; and
the slave processing unit controls the slave action unit to display a picture with the multiple equally spaced LED lights according to the relay command.

19. The automatic light signaling bicycle communication system as claimed in claim 18, wherein:
the picture file in the external master device is in one or more than one bitmap format, and the picture displayed by the slave module is an animated icon;
the slave processing unit controls the slave action unit to display the picture according to a display frequency information specified in the relay command; and
when the display frequency information specifies a display frequency higher than 1 Hz, the slave processing unit then controls the slave action unit to blink the picture according to the display frequency.

20. The automatic light signaling bicycle communication system as claimed in claim 3, wherein:
the slave module is a brake of a bicycle; the slave action unit is a sensitivity control unit of the brake of the bicycle;
when the external master device generates a raise sensitivity command as the command, the external master device sends the command to the relay processing unit; the relay processing unit relays the raise sensitivity command as the relay command to the sensitivity control unit of the brake of the bicycle; and the slave processing unit controls the slave action unit to raise sensitivity of the brake according to the raise sensitivity command; and
when the external master device generates a lower sensitivity command as the command, the external master device sends the command to the relay processing unit; the relay processing unit relays the lower sensitivity command as the relay command to the sensitivity control unit of the brake of the bicycle; and the slave processing unit controls the slave action unit to lower sensitivity of the brake according to the lower sensitivity command.
